(19) United States
(12) Patent Application Publication
(10) Pub. No.: US 2007/0130369 A1
(43) Pub. Date: Jun. 7, 2007

(54) Email and Taskmanaging Software

(76) Inventor: Vasant Nayak, Lutherville, MD (US)

Correspondence Address: GREENBERG & LIEBERMAN, LLC, 2141 WISCONSIN AVE, N.W., SUITE C-2, WASHINGTON, DC, 20007, US

(21) Appl. No.: 11/567,578

(22) Filed: Dec. 6, 2006

Related U.S. Application Data
(60) Provisional application No. 60/597,500, filed on Dec. 6, 2005.

(51) Int. Cl. G06F 15/16

(52) U.S. Cl. 709/246

(57) ABSTRACT

An email and task-managing software for Microsoft Outlook users. An additional button on the user's Outlook toolbar enables the user to save emails and email attachments into notes, attachments, appointments, tasks, regular lists and to-do lists in related folders which can be easily accessed at a later time. It is a system that increases the organizational capabilities of Outlook and helps a user become more aware of their obligations, prioritize, classify and organize information.

This is a non-provisional application of provisional application No. 60/597,500 filed on Dec. 6, 2005, and priority is claimed thereto.

### FIELD OF THE INVENTION

The present invention relates to a software that enables Microsoft Office Outlook to organize, prioritize and task-manage incoming emails like never before for a user.

### BACKGROUND OF THE INVENTION

Electronic mail has greatly improved communications between people and has made communicating more easy, fast and efficient; it has also enabled people to stay in touch from virtually anywhere in the world. Nonetheless, like any good thing, email also has its drawbacks. There is no system set up that can sort through the non-junk emails and organize important emails into tasks/events, and generally there is no such system in place to prevent important emails from getting lost in the inbox and the plethora of spam mail and other non-essential communications.

Busy professionals who have hectic schedules may not have the time necessary to sort through endless emails, and may have a hard time remembering particular details about the various emails they receive. While some people may have both a personal and work account, others may use primarily one email. A user may have important emails coming into the same account from co-workers, bosses, friends, family and spouses, in addition to the junk mail that is inevitably received. In the same few minutes, for example, a person may receive an electronic billing statement, a request from a supervisor, a suggestion from a co-worker, a shopping list from a spouse, and several spam messages. Sorting through all of the information, organizing and prioritizing can be an arduous and time-consuming task. This is not simply limited to the workplace either, but occurs at home as well, taking time away from important things like family and leisure.

Microsoft Office's Outlook is an email server that allows a person to do a variety of tasks; however, there is no software in place to sort through the important emails and convert them into usable files and information. For example, it is difficult to convert email content into to-do lists and possible appointments or even store the message as a note. Saving an email attachment in the appropriate folders to the hard drive of the PC is inconvenient, since those attachments can be hard to find and retrieve.

Hence, there exists a need for a software system that will enable Microsoft Office Outlook to task-manage, prioritize and organize important incoming emails. This would make life considerably easier for busy people and it would serve as a convenient solution to people needing help managing their important email messages.

### SUMMARY OF THE INVENTION

The present invention is a software program that acts as an additional feature of Microsoft Office Outlook. The software program is designated as “eMail2Do.” With the software, it is easy to convert email into tasks, notes, appointments, while assigning categories and deadlines. Attachments from incoming emails can be stored in related folders and easily located at a later time.

eMail2Do is a simple method of organizing important information received in an email account. It is presented with an intuitive interface in a centralized location on Outlook, so the user can see their various options clearly. It facilitates the user's decision-making process upon determining what to do with the information presented in the emails, thereby providing greater efficiency and increasing productivity.

### BRIEF DESCRIPTION OF THE DRAWINGS

FIG. 1 is a view of the eMail2Do button on the toolbar.

FIG. 2 is a view of eMail2Do program window/workspace.

### DETAILED DESCRIPTION OF THE PREFERRED EMBODIMENT

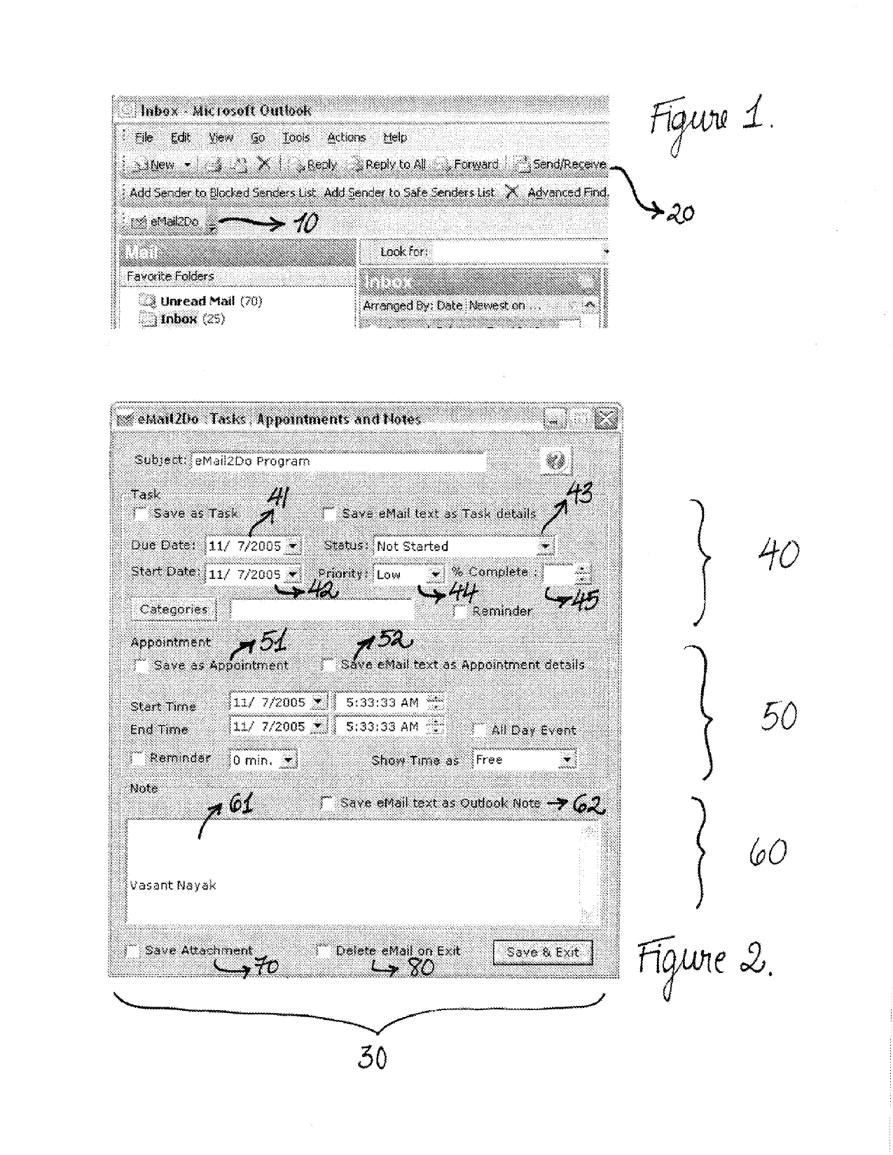

The present invention is a software system that is used with Microsoft Outlook. The present invention is simple and convenient to use. As shown in FIG. 1, eMail2Do is an additional button (10) on the Outlook toolbar (20). When the user clicks on the email2Do button, an eMail2Do window (30) will pop up on the user's screen.

As shown in FIG. 2, the eMail2Do window and workspace (30) has separate areas for tasks (40), appointments (50) and notes (60). The tasks (40) can be assigned a due date (41), start date (42), status (43) and priority (44), as well as a percentage of completion (45). The assignment section (50) can save an appointment (51) or save eMail directly as an appointment (52). The notes section (60) allows for a space where a note can be written (61), or an eMail text can be saved directly as an Outlook Note (62).

Additionally, a user can save attachments (70) and delete the applicable eMail (80) upon closing the eMail2Do window (30). Therefore, the user can immediately organize and prioritize information from eMails while keeping the eMail Inbox uncluttered.

With eMail2Do, a user can create and save information from existing emails. A user can create a task, appointment or both simultaneously. Additionally, they can save an email body-text to notes belonging to a task or appointment; and can save an email body-text to Outlook Notes. Attachments can be saved to an appropriate folder on the hard drive.

The software is very small in size and is fast to download and hardly uses up the computer system resources. It is simple to install with no complicated decisions or choices to be made by the user. After a quick installation, it gets incorporated into the Outlook tools bar and is accessible very easily. There is no separate program to invoke.

Having illustrated the present invention, it should be understood that various adjustments and versions might be implemented without venturing away from the essence of the present invention. The present invention is not limited to the embodiments as described above.

I claim:

1. An email and task-managing software process, comprising:
Clicking a button on an email interface; and
Converting an email or email attachments into one of the following group, via clicking the button: notes, attachments, appointments, tasks, regular lists and to-do lists.
